(19) United States
(12) Patent Application Publication
(10) Pub. No.: US 2022/0280007 A1
(43) Pub. Date: Sep. 8, 2022

(54) MOBILE ROBOT AND METHOD OF CONTROLLING THE SAME

(71) Applicant: LG ELECTRONICS INC., Seoul (KR)

(72) Inventor: Hyunjin JANG, Seoul (KR)

(73) Assignee: LG ELECTRONICS INC., Seoul (KR)

(21) Appl. No.: 17/626,359

(22) PCT Filed: Jul. 9, 2020
(86) PCT No.: PCT/KR2020/009044

§ 371 Date: Jan. 11, 2022

(30) Foreign Application Priority Data
Jul. 11, 2019 (KR) 10-2019-0083685

(51) Int. Cl. A47L 11/40; G05D 1/02; G05D 1/00; G06F 3/16

(52) U.S. Cl. CPC A47L 11/4011; G05D 1/0219; G05D 1/0238; G05D 1/0246; G05D 1/0255; G05D 1/005; G05D 1/0044; G06F 3/167; A47L 2201/04; A47L 2201/06; G05D 2201/0203

(57) ABSTRACT

Provided are a mobile robot and a method of controlling the same, which store dust information detected during travel, store the dust information and information about a surrounding object, determine a cleaning command for dust or a cleaning command for the object to set cleaning, and output guidance for the set cleaning by voice, thus allowing a user to easily check information about dust in a region, and cleaning dust or the object with a simple command.

### TECHNICAL FIELD

The present disclosure relates to a mobile robot and a method of controlling the same and, more particularly, to a mobile robot and a method of controlling the same, which provide dust information about a region based on the amount of dust sensed through a dust sensor.

### BACKGROUND

Generally, a mobile robot travels by itself within a region to perform a predetermined operation. For example, a cleaning robot sucks foreign matter such as dust from a floor to automatically clean it.

The mobile robot may create a map for an associated region while travelling in a region to be cleaned. The mobile robot may perform a cleaning operation while travelling based on the created map.

The mobile robot may perform the cleaning operation while sensing dust during cleaning.

Korean Patent Laid-Open Publication No. 1998-0022987 describes a vacuum cleaner which repeatedly travels and increases a suction force to perform a cleaning operation when the amount of dust sensed at a suction port is greater than a reference amount.

Korean Patent Laid-Open Publication No. 2015-0029299 is configured to set a travel route according to the sensing result of a plurality of dust sensors and to determine a cleaning state.

However, a conventional mobile robot may sense the amount of dust during cleaning to improve cleaning performance, but there is a limitation in using information about the sensed amount of dust.

According to the prior art, dust information in a region as the cleaning operation is performed, that is, the amount of dust in a specific position is not stored on the map. Thus, this is problematic in that a user may not check the dust information of the region.

Although there are dusty points even in the same region depending on the surrounding environment, a user may not check the dusty points. Thus, there is a problem that noise may be undesirably increased due to a prolonged stay of the robot in a specific region or a change in suction force.

### SUMMARY

The present disclosure provides a mobile robot and a method of controlling the same, which visually and audibly provide dust information for each region by displaying dust information on a map based on the amount of dust sensed during cleaning.

The present disclosure also provides a mobile robot and a method of controlling the same, which store dust information for each region by storing related information and position information if a dust sensor is operated, and allow a user to easily check the amount of dust based on accumulated information about dust.

The present disclosure provides a mobile robot and a method of controlling the same, which divide dusty points in stages according to the amount of dust, and match the dusty points with surrounding objects, thus providing dust information.

The present disclosure provides a mobile robot and a method of controlling the same, which perform a cleaning operation based on dust information.

Technical objects to be achieved by the present disclosure are not limited to the aforementioned technical objects, and other technical objects not described above may be evidently understood by a person having ordinary skill in the art to which the present disclosure pertains from the following description.

In order to accomplish the above objects, a mobile robot and a control method thereof according to an embodiment of the present disclosure are intended to visually or audibly provide dust information for each region by displaying dust information on a map based on the sensed amount of dust.

The present disclosure is intended to divide dusty points in stages according to the amount of dust, and match the dusty points with surrounding objects, thus providing dust information.

The present disclosure is intended to perform a cleaning operation based on an object disposed in a region even in a situation where a position within the region is not specified.

The present disclosure is intended to clean a specific region corresponding to a voice command by recognizing the voice command.

The present disclosure is intended to output a cleaning status and dust information in a voice.

In an aspect, the present disclosure provides a mobile robot including a main body configured to travel in a region; a driving unit configured to move the main body; a dust sensor configured to detect dust; and a control unit configured to store dust information detected by the dust sensor during the travel, and to match information about a dusty point with information about an object located around the dusty point from the dust information, thus performing a cleaning operation on the basis of the dust information or the object.

The control unit may set a cleaning position based on the dust information, if a cleaning command for dust is input, and may set a cleaning position according to surrounding dust information on the basis of a surrounding region of the corresponding object, if a cleaning command for the object is input.

The mobile robot may further include an image acquisition unit configured to photograph surroundings of the main body; and an obstacle recognition unit configured to recognize an object by analyzing an image photographed by the image acquisition unit, so that a cleaning command is determined by matching with the dust information based on information about the object, which is recognized through the obstacle recognition unit.

The control unit may determine the object located around the dusty point, by comparing a dust position based on the dust information and a position of the object, based on information about the object, or match the dust information with the object, by calculating the dusty point around the object.

The mobile robot may further include an audio input unit configured to collect sound; and an output unit configured to output voice guidance, and the control unit may generate a response message, based on a voice recognition result for a voice command which is input through the audio input unit, and then outputs the response message through the output unit by voice.

In an aspect, the present disclosure provides a method of controlling a mobile robot including detecting dust by a dust sensor during travel; storing dust detection and a position of a main body; calculating a dust detected position and a number of dust detections at that position when cleaning has been completed, and calculating a dusty point, thus storing the dusty point as dust information; matching and storing information about an object located around the dusty point; and setting and cleaning a region to be cleaned base on the dust information or a position of the object, according to an input cleaning command.

The method may further include setting a cleaning position based on the dust information, if a cleaning command for dust is input; and setting a cleaning position on the basis of surrounding dust information about a surrounding region of the corresponding object, if a cleaning command is input based on the object.

The method may further include inputting a voice command; and generating a response message, based on a voice recognition result for the voice command, and then outputting the response message by voice.

The response message including at least one of a cleaning reason, a dust position, a cleaning position, and a cleaning method may be output by voice.

Voice guidance about the cleaning position may be output based on the object.

### Advantageous Effects

A mobile robot and a control method thereof according to the present disclosure can store dust information about a position where a dust sensor is operated and the amount of dust, and allow a user to easily check the amount of dust based on accumulated dust information.

The present disclosure is advantageous in that the visualized dust information is provided, so the understanding of the operation of a mobile robot at a dusty point is increased and a user's dissatisfaction is solved.

The present disclosure is advantageous in that the amount of dust is not simply displayed on a map by only a position, but dust information is provided through matching with surrounding objects, so that even a user who does not understand the map can easily check the dust information based on an object.

The present disclosure is advantageous in that a cleaning operation can be performed only with a cleaning command for the surrounding of a specific object or the amount of dust, even when a position within a region is not specified.

The present disclosure is advantageous in that a cleaning operation can be performed on a specific region even with various types of commands or simple commands, so that a user's convenience is improved.

### BRIEF DESCRIPTION OF THE DRAWINGS

FIG. 1 is a perspective view illustrating a mobile robot according to an embodiment of the present disclosure.

FIG. 2 is a block diagram specifically illustrating the configuration of the mobile robot according to an embodiment of the present disclosure.

FIG. 3 is a diagram illustrating a map of the mobile robot according to an embodiment of the present disclosure.

FIG. 4 is a diagram illustrating a terminal on which a map including dust information of the mobile robot according to an embodiment of the present disclosure is displayed.

FIG. 5 is a diagram illustrating the map including the dust information of the mobile robot according to an embodiment of the present disclosure.

FIGS. 6 and 7 are diagrams illustrating a control method using a voice command of the mobile robot according to an embodiment of the present disclosure.

FIG. 8 is a flowchart illustrating a control method of the mobile robot according to an embodiment of the present disclosure.

FIG. 9 is a diagram illustrating the dust information of the mobile robot according to an embodiment of the present disclosure.

FIG. 10 is a flowchart illustrating a cleaning method according to the dust information of the mobile robot according to an embodiment of the present disclosure.

### DETAILED DESCRIPTION

The above and other objectives, features, and other advantages of the present disclosure will be more clearly understood from the following detailed description when taken in conjunction with the accompanying drawings. However, the present disclosure may be embodied in different forms without being limited to the embodiments set forth herein. Rather, the embodiments disclosed herein are provided to make the disclosure thorough and complete and to sufficiently convey the spirit of the present disclosure to those skilled in the art. The present disclosure is to be defined by the claims. Like reference numerals refer to like parts throughout various figures and embodiments of the present disclosure. The control configuration of the present disclosure may include at least one processor.

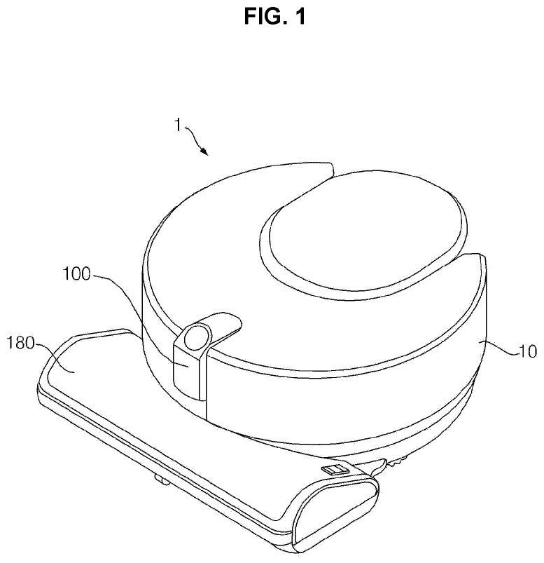

FIG. 1 is a perspective view illustrating a mobile robot according to an embodiment of the present disclosure.

Referring to FIG. 1, the mobile robot 1 according to an embodiment of the present disclosure is configured to move in a region and suck foreign matter such as dust from a floor during travelling.

The mobile robot 1 includes a main body 10 which performs a predetermined operation, an obstacle sensing unit 100 which is disposed on a front of the main body 10 to sense an obstacle, and an image acquisition unit 170 which photographs the image of 360 degrees.

The main body 10 may include a casing (not shown) which defines an appearance and defines therein a space in which components forming the main body 10 are accommodated, and a left wheel (not shown) and a right wheel (not shown) which are rotatably provided on the casing. Furthermore, the mobile robot includes a suction unit 180, which is disposed on the casing and is formed towards a floor to suck foreign matter such as dust or garbage, thus performing a cleaning operation.

The main body 10 moves along the floor of the region as the left wheel and the right wheel rotate. The main body 10 may include a driving unit (not shown) which drives the left wheel and the right wheel. The driving unit may include at least one driving motor.

The suction unit 180 may include a suction fan (not shown) which generates a suction force, and a suction port (not shown) through which air current generated by the rotation of the suction fan is sucked. The suction unit may include a filter (not shown) which collects foreign matter from the air current sucked through the suction port, and a foreign-matter collecting container (not shown) in which foreign matter collected by the filter is accumulated.

The suction unit 180 includes a rotary brush (not shown) to suck the air current and simultaneously rotate, thus aiding in collecting the foreign matter. The suction unit is configured to be detachably attached as necessary. The main body 10 may further include a plurality of brushes (not shown) which are located on the front side of the bottom of the casing and include a plurality of wings extending radially.

Furthermore, a wet-mop cleaning unit may be detachably attached to the suction unit 180. The wet-mop cleaning unit may be mounted on the rear of the suction port. In some cases, the wet-mop cleaning unit may be configured separately from the suction unit, and may be replaced and installed at a position where it is fixedly fastened to the suction unit. The wet-mop cleaning unit rotates while moving and wipes the floor in a travel direction.

The main body 10 may further include the plurality of brushes (not shown) which are located on the front side of the bottom of the casing and include a plurality of wings extending radially. The brushes remove dust from the floor of a cleaning region by rotation. The dust separated from the floor is sucked through the suction port and then is collected in the collecting container.

A control panel including a manipulation unit (not shown) which receives various commands for controlling the mobile robot 1 from a user may be provided on the top of the casing.

Furthermore, the image acquisition unit (not shown) and the obstacle sensing unit 100 are disposed on the front or top of the main body.

The obstacle sensing unit 100 senses an obstacle located in the travel direction or around the main body 10.

The image acquisition unit photographs an image for an indoor region. Based on the image photographed by the image acquisition unit, it is possible to monitor the indoor region as well as detect the obstacle around the main body.

The image acquisition unit 170 may be disposed forwards and upwards at a predetermined angle to photograph the front and top of the mobile robot. The image acquisition unit may further include a separate camera which photographs the front.

Furthermore, the image acquisition unit may be disposed on the top of the main body 10 to face a ceiling, and may be provided with a plurality of cameras according to circumstances.

Furthermore, the image acquisition unit may be provided with a camera which photographs the floor.

The mobile robot 1 may further include a position acquisition means (not shown) for acquiring current position information. The mobile robot 1 may include a GPS and a UWB to determine a current position. Further, the mobile robot 1 may determine the current position using the image.

The main body 10 may be provided with a rechargeable battery (not shown), a charging terminal (not shown) of the battery may be connected to a commercial power source (e.g., a power outlet at home), the main body 10 may be docked in a separate charging station (not shown) connected to the commercial power source, so that the charging terminal may be electrically connected to the commercial power source through contact with a terminal of a charging station, and the battery may be charged. Electronic components forming the mobile robot 1 may receive power from the battery. Thus, in a state where the battery is charged, the mobile robot 1 may self-drive while being electrically separated from the commercial power source.

Hereinafter, the mobile robot 1 will be described as an example of a mobile robot for cleaning. However, without being limited thereto, any robot is applicable as long as it autonomously drives in a region and senses sound.

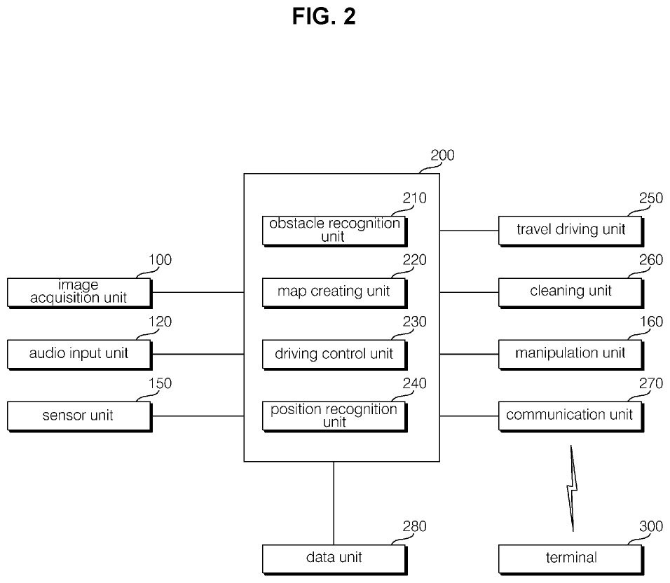

FIG. 2 is a block diagram specifically illustrating the configuration of the mobile robot according to an embodiment of the present disclosure.

As shown in FIG. 2, the mobile robot 1 may include a driving unit 290, a cleaning unit 260, a data unit 280, an obstacle sensing unit 100, an audio input unit 120, an image acquisition unit 170, a sensor unit 150, a communication unit 270, a manipulation unit 160, an output unit 190, and a control unit 200 which controls the overall operation.

The manipulation unit 160 includes an input means such as at least one button, switch, or touch pad to receive a user command. As described above, the manipulation unit may be provided on the upper end of the main body 10.

The output unit is provided with a display such as an LED or an LCD to display the operation mode, reservation information, battery status, operation status, and error status of the mobile robot 1. Furthermore, the output unit 190 is provided with a speaker or a buzzer to output a predetermined effect sound, warning sound or voice guidance corresponding to the operation mode, the reservation information, the battery status, the operation status, and the error status.

The audio input unit 120 includes at least one microphone to receive a sound generated in the periphery or region within a certain distance from the main body 10.

The audio input unit 120 may further include a signal processing unit (not shown) which filters, amplifies and converts an input sound.

The data unit 280 stores an acquisition image which is input from an image acquisition unit 170, reference data for determining the obstacle by the obstacle recognition unit 210, and obstacle information about the sensed obstacle.

The data unit 280 stores obstacle data for determining the type of the obstacle, image data on a photographed image, and map data on a region. The map data includes the obstacle information, and stores various types of maps for a drivable region searched by the mobile robot.

Furthermore, the data unit 280 stores sound data for discriminating input sounds, data for recognizing voice, and data on effect sound, warning sound, and voice guidance which are output through the output unit.

The data unit 280 may include images photographed by the image acquisition unit, for example, a still image, a moving image, and a panoramic image. Furthermore, the data unit 280 stores a control data for controlling the operation of the mobile robot, data according to the cleaning mode of the mobile robot, and a detection signal such as ultrasound/laser sensed by the sensor unit 150.

Furthermore, the data unit 280 stores sound which may be read by a micro processor, and may include a hard disk drive (HDD), a solid state disk (SSD), a silicon disk drive (SDD), a ROM, a RAM, a CD-ROM, magnetic tape, floppy disk, and an optical data storage device

The communication unit 270 communicates with a terminal 300 in a wireless communication method. Furthermore, the communication unit 270 may be connected to an Internet network through an in-home network, and communicate with an external server or the terminal 300 which controls the mobile robot.

The communication unit 270 transmits the created map to the terminal 300, receives a cleaning command from the terminal, and transmits data on the operation status and the cleaning status of the mobile robot to the terminal. Furthermore, the communication unit 270 may transmit information about the obstacle, which is sensed while driving, to the terminal 300 or the server. The communication unit 270 includes a communication module such as a short-range wireless communication such as Zigbee and Bluetooth, Wi-Fi, and WiBro to transmit and receive data.

The communication unit 270 may communicate with a charging station 40, and may receive a charging-stand return signal or a guide signal for docking the charging station. The mobile robot 1 searches for a charging station based on a signal received through the communication unit 270, and docks with the charging station.

On the other hand, the terminal 300 is a device which is equipped with a communication module to be accessible to a network, and in which a program for controlling the mobile robot or an application for controlling the mobile robot is installed, and may use a device such as a computer, a laptop, a smartphone, a PDA, and a tablet PC. Furthermore, the terminal may also use a wearable device such as a smart watch.

The terminal 300 may output a predetermined warning sound or display a received image according to data received from the mobile robot 1.

The terminal 300 may receive the data of the mobile robot 1 to monitor the operation status of the mobile robot, and control the mobile robot 1 through a control command.

The terminal 300 may make a one-to-one direct connection with the mobile robot 1, and may also be connected through a server, for example, a home-appliance management server. The driving unit 290 includes at least one driving motor to cause the mobile robot to be driven in response to the control command of a driving control unit 230. As described above, the driving unit 290 may include a left-wheel driving motor for rotating the left wheel and a right-wheel driving motor for rotating the right wheel.

The cleaning unit 260 operates a brush to make it easy to suck dust or foreign matter around the mobile robot, and operates a suction device to suck the dust or the foreign matter. The cleaning unit 260 controls the operation of the suction fan which is provided in the suction unit for sucking the foreign matter such as dust or garbage, thus causing dust to be put through the suction port into the foreign-matter collecting container.

Furthermore, the cleaning unit 260 may further include a wet-mop cleaning unit (not shown) which is installed at the rear of the bottom of the main body to contact the floor and wipe the floor, and a water container (not shown) which supplies water to the wet-mop cleaning unit. The cleaning unit 260 may be equipped with a cleaning tool. For example, a wet mop pad may be attached to the wet-mop cleaning unit to clean the floor. The cleaning unit 260 may further include a separate driving means which transmits a rotating force to the wet mop pad of the wet-mop cleaning unit.

The battery (not shown) supplies power required for the overall operation of the mobile robot 1 as well as the driving motor. When the battery is discharged, the mobile robot 1 may travel to return to the charging station for charging the mobile robot. During such a return travel, the mobile robot 1 itself may detect the position of the charging station. The charging station may include a signal sending unit (not shown) which sends a predetermined return signal. The return signal may be an ultrasound signal or an infrared signal, but is not necessarily limited thereto. The obstacle sensing unit 100 radiates a predetermined pattern to acquire the radiated pattern as an image. The obstacle sensing unit may include at least one pattern radiation unit (not shown) and a pattern acquisition unit. Further, the obstacle sensing unit may include a sensor such as an ultrasound sensor, a laser sensor, an infrared sensor, or a 3D sensor to sense the position, distance, and size of the obstacle located in the travel direction. Furthermore, the obstacle sensing unit 100 may sense the obstacle as an image in the travel direction. Both the sensor unit and the image acquisition unit may be included in the obstacle sensing unit.

The sensor unit 150 includes a plurality of sensors to sense the obstacle. The sensor unit 150 senses the obstacle at a front position, that is, in the travel direction using at least one of an ultrasound sensor, a laser sensor, and an infrared sensor. The sensor unit 150 may be used as an auxiliary means for sensing an obstacle which is not sensed by the obstacle sensing unit.

Furthermore, the sensor unit 150 may further include a cliff detection sensor which detects whether a cliff exists on the floor in a travel region. When the sent signal is reflected and incident, the sensor unit 150 inputs information about the presence of the obstacle or a distance to the obstacle into the control unit 200 as an obstacle detection signal.

The sensor unit 150 includes a dust sensor. The dust sensor may be installed adjacent to the suction port of the suction unit 180. If the dust is sensed, the dust sensor generates a detection signal to detect the amount of dust.

The sensor unit 150 includes at least one inclination sensor to sense the inclination of the main body. When the inclination sensor is inclined forwards, backwards, leftwards, and rightwards relative to the main body, the inclined direction and angle are calculated. The inclination sensor may use a tilt sensor, an acceleration sensor, etc. For the acceleration sensor, any of a gyro type, inertial type, and silicon semiconductor type may be applied.

Furthermore, the sensor unit 150 may detect an operation status or abnormality through a sensor installed in the mobile robot 1.

The image acquisition unit 170 includes at least one camera.

The image acquisition unit 170 may include a camera which converts the image of a subject into an electrical signal, converts it into a digital signal again, and stores the digital signal in a memory device. The camera may include at least one optical lens, an image sensor (e.g., CMOS image sensor) including multiple photodiodes (e.g., pixels) on which an image is formed by light passing through the optical lens, and a digital signal processor (DSP) forming the image based on signals output from the optical diodes. The digital signal processor may generate a still image as well as a moving image having frames formed of still images.

The image sensor is a device which converts an optical image into an electrical signal and is formed of a chip in which multiple photo diodes are integrated. Examples of the photo diode may include a pixel. Charges may be accumulated in the pixels by the image formed on the chip by light passing through the lens, and the charges accumulated in the pixels are converted into an electrical signal (e.g., voltage). As the image sensor, a CCD (Charge Coupled Device), a CMOS (Complementary Metal Oxide Semiconductor), etc. are well known.

If the mobile robot is operated, the image acquisition unit 170 continuously photographs an image. Furthermore, the image acquisition unit 170 may photograph an image on the basis of a predetermined period or a predetermined distance.

The image acquisition unit 170 may set a photographing period according to the moving speed of the mobile robot.

The image acquisition unit 170 may acquire an image at a front position in the travel direction, and photograph a ceiling shape.

The image acquisition unit 170 stores an image photographed while the main body is travelling in the data unit 280 as image data.

The obstacle sensing unit inputs information about the position or movement of the sensed obstacle into the control unit 200. The sensor unit 150 may input the detection signal for the obstacle sensed by the sensor into the control unit. The image acquisition unit 170 inputs the photographed image into the control unit.

The control unit 200 controls the driving unit 290 so that the mobile robot is driven in a predetermined region of the travel region.

The control unit 200 processes data input by the manipulation of the manipulation unit 160 to set the operation mode of the mobile robot, outputs the operation status through the output unit 190, and outputs the warning sound, the effect sound, or the voice guidance through the speaker of the output unit as the operation status, the error state or the obstacle is detected.

The control unit 200 creates the map for the travel region based on the image acquired from the image acquisition unit 170 or the obstacle information sensed from the sensor unit 150 or the obstacle sensing unit 100. The control unit 200 may create the map based on the obstacle information during the travel in the region, and determine the shape of the travel region from the image of the image acquisition unit to create the map.

The control unit 200 recognizes the obstacle with respect to the obstacle detected by the image acquisition unit 170 or the obstacle sensing unit 100, and controls the driving unit to perform a specific operation or change a route in response to the recognized obstacle. Furthermore, the control unit may output a predetermined effect sound or warning sound through the output unit as necessary, and control the image acquisition unit to photograph the image.

Furthermore, the control unit 200 calculates and stores the amount of dust detected by the dust sensor of the sensor unit 150 during the travel. When the dust is detected by the dust sensor, the control unit 200 determines the position of the main body to store information about dust and position information as dust data.

The control unit 200 may store dust information by matching with a surrounding object, according to the amount of dust. Dust information about the periphery may be stored on the basis of an obstacle in a region detected by the obstacle recognition unit 210 which will be described later, that is, an object located in a region.

The control unit 200 indicates a position where dust is sensed on the map based on the accumulated and stored dust information, thus updating the map. The control unit 200 divides an operation into a plurality of steps depending on the amount of dust, so that the dust information is included in the map for each stage.

The control unit 200 may recognize voice by analyzing sound which is input through the audio input unit 120. In some cases, the control unit 200 may transmit the input sound to a voice recognition server (not shown) to recognize the input voice. When the voice recognition has been completed, the control unit 200 performs an operation corresponding to a voice command.

Furthermore, the control unit 200 outputs the voice guidance corresponding to the voice command through the speaker of the output unit 190.

The control unit 200 controls the driving unit 290 and the cleaning unit 260 during the travel to absorb dust or foreign matter around the mobile robot, thereby cleaning the travel region. Thus, the cleaning unit 260 operates the brush to make it easy to suck dust or foreign matter around the mobile robot, and operates the suction device to suck the dust or the foreign matter. The cleaning unit is controlled to suck the foreign matter and perform the cleaning operation during the travel.

The control unit 200 checks the charging capacity of the battery to determine time to return to the charging station. If the charging capacity reaches a predetermined value, the control unit 200 stops the operation which is being performed, and starts searching for the charging station to return to the charging station. The control unit 200 may output a notification about the charging capacity of the battery and a notification about the return to the charging station. Furthermore, when the signal transmitted from the charging station is received through the communication unit 270, the control unit 200 may return to the charging station.

The control unit 200 includes an obstacle recognition unit 210, a map creating unit 220, a driving control unit 230, and a position recognition unit 240.

In the initial operation or when the map for the region is not stored, the map creating unit 220 creates the map for the region based on the obstacle information while traveling in the region. Furthermore, the map creating unit 220 updates a previously created map, based on the obstacle information acquired during the travel. Furthermore, the map creating unit 220 analyzes the image acquired during the travel to determine the shape of the region and thereby create the map.

The map creating unit 220 divides the cleaning region into a plurality of regions after generating a basic map, includes a connection passage connecting a plurality of regions, and creates a map including information about the obstacle in each region.

The map creating unit 220 processes the shape of the region for each divided region. The map creating unit 220 may set attributes for the divided region.

Furthermore, the map creating unit 220 may divide the region from features extracted from the image. The map creating unit 220 may determine the position of a door based on a connection relationship between the features, and thereby create the map having a plurality of regions by forming a boundary between regions.

The map creating unit 220 may update the map by including dust information sensed through the dust sensor in the map. Furthermore, when the type of the obstacle is determined by the obstacle recognition unit, the map creating unit 220 updates the map so that the dust information is displayed on the map by matching the type of obstacle, that is, the object located in the region with the dust information.

The obstacle recognition unit 210 determines the obstacle through data which is input from the image acquisition unit 170 or the obstacle sensing unit 100, the map creating unit 220 creates the map for the travel region, and information about the sensed obstacle is included in the map.

The obstacle recognition unit 210 analyzes data which is input from the obstacle sensing unit 100 to determine the obstacle. The direction of the obstacle or the distance to the obstacle is calculated in response to the detection signal of the obstacle sensing unit, for example, an ultrasound or laser signal. Furthermore, the obstacle recognition unit may analyze the acquired image including the pattern to extract the pattern, and analyze the shape of the pattern to determine the obstacle. In the case of using the ultrasound or infrared signal, the obstacle recognition unit 210 determines the obstacle based on differences in the shape of ultrasound waves received according to a distance to the obstacle or a position of the obstacle, and time when the ultrasound waves are received.

The obstacle recognition unit 210 may analyze the image photographed through the image acquisition unit 170 to determine the obstacle located around the main body.

The obstacle recognition unit 210 may detect a human body. The obstacle recognition unit 210 may analyze data which is input through the obstacle sensing unit 100 or the image acquisition unit 170 to detect the human body based on a silhouette, a size, a face shape, etc. and determine whether the human body is a registered user or not.

The obstacle recognition unit 210 analyzes image data to extract it as the feature of the obstacle, determines the obstacle based on the shape (form), size, and color of the obstacle, and determines the position.

The obstacle recognition unit 210 may determine the type of the obstacle by extracting the features of the obstacle based on pre-stored obstacle data excluding the background of the image from the image data. The obstacle data 181 is updated by new obstacle data which is received from the server. The mobile robot 1 may store obstacle data on the sensed obstacle, and receive data on the type of the obstacle from the server.

Furthermore, the obstacle recognition unit 210 stores information of the recognized obstacle in the obstacle data, and transmits recognizable image data through the communication unit 270 to the server 90, thus determining the type of the obstacle. The communication unit 270 transmits at least one image data to the server 90.

The obstacle recognition unit 210 determines the obstacle based on the image data converted by an image processor.

The position recognition unit 240 calculates the current position of the main body. The position recognition unit 240 may extract the features from the image of the image acquisition unit, that is, the image data, compare the features and thereby determine the current position. The position recognition unit 240 may determine the current position using a structure around the main body, the shape of a ceiling, etc. from the image.

The position recognition unit 240 detects features such as points, lines, and planes for predetermined pixels forming the image, and analyzes the features of the region based on the detected features, thus determining the position. The position recognition unit 240 may extract the outline of the ceiling to extract features such as lighting.

The position recognition unit continuously determines the current position in the region through the image data, matches the features, reflects and learns changes in surrounding structures, and calculates a position.

The driving control unit 230 controls the driving unit 290 to travel in the region based on the map, pass through the obstacle or avoid the obstacle by changing the moving direction or the travel route in response to the sensed obstacle information.

The driving control unit 230 controls the driving unit 290 to independently control the operation of the left-wheel driving motor and the right-wheel driving motor, thus allowing the main body 10 to move straight or rotate. The driving control unit 230 controls the driving unit 290 and the cleaning unit 260 according to a cleaning command so that the main body 10 sucks foreign matter to perform the cleaning operation while traveling in the cleaning region.

The driving control unit 230 controls the driving unit 290 to move to a region which is set based on the map created by the map creating unit 220, or to move the main body within the set region. Furthermore, the driving control unit 230 controls the driving based on the current position calculated from the position recognition unit 240.

The driving control unit 230 controls the driving unit to perform a predetermined operation corresponding to the obstacle or to change the travel route in response to the detection signal of the obstacle sensing unit 100.

The driving control unit 230 controls the driving unit to perform at least one of avoidance, approach, setting of the approach distance, stopping, decelerating, accelerating, reverse driving, U-turn, and change of the driving direction in response to the detected obstacle.

Furthermore, the driving control unit 230 may output an error, and output a predetermined warning sound or voice guidance, if necessary.

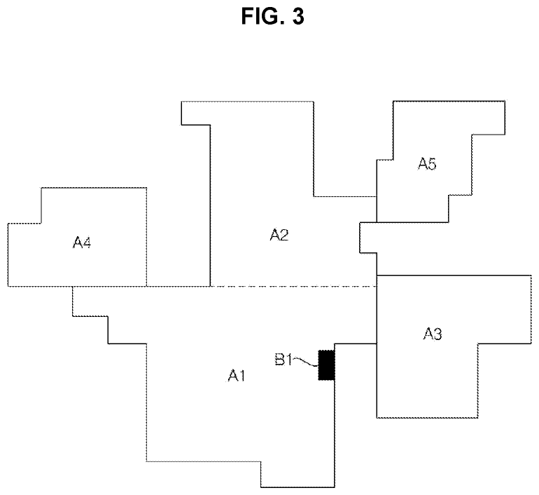

FIG. 3 is a diagram illustrating the map of the mobile robot according to an embodiment of the present disclosure.

As shown in FIG. 3, in the initial operation or when the map is not stored, the mobile robot 1 may create the map for the region while traveling in the region. For example, the mobile robot 1 creates the map based on information acquired through the obstacle sensing unit, the sensor unit, and the image acquisition unit, through wall following, obstacle sensing, etc. Furthermore, the mobile robot 1 may receive the map data from the terminal 80 or the server 90.

The mobile robot 1 may create the map through the obstacle information acquired while cleaning the cleaning region in a state where there is no map, and update the previously stored map.

The map creating unit 220 creates the map based on data which is input from the image acquisition unit 170, the obstacle sensing unit 100 and the sensor unit 150, and obstacle information, during the travel. Furthermore, the map creating unit 220 may divide a region into a plurality of regions, and store information for each divided region.

The map creating unit 220 may create a map by dividing a region in which the mobile robot travels into first to fifth regions A1 to A5. The map creating unit 220 may extract the position of the door from the image to divide the region, and may also divide the region through the expansion and contraction of the basic map.

The map creating unit 220 updates the map including the obstacle information and the dust information sensed during the travel. Furthermore, the map creating unit 220 may indicate the position of the charging station B1 on the map.

The terminal 300 may display the map received from the mobile robot 1 on a screen, and input a cleaning command on the basis of a region according to a user's input.

Thus, the mobile robot 1 performs the cleaning operation while moving in a predetermined region. The dust sensor stores the amount of dust sensed during the cleaning operation, and the amount of stored dust is accumulated and reflected on the map as the dust information.

Furthermore, the mobile robot 1 may detect the obstacle through the obstacle sensing unit 100 to perform a corresponding operation, and update the map by including the information, position or size of the detected obstacle in the map.

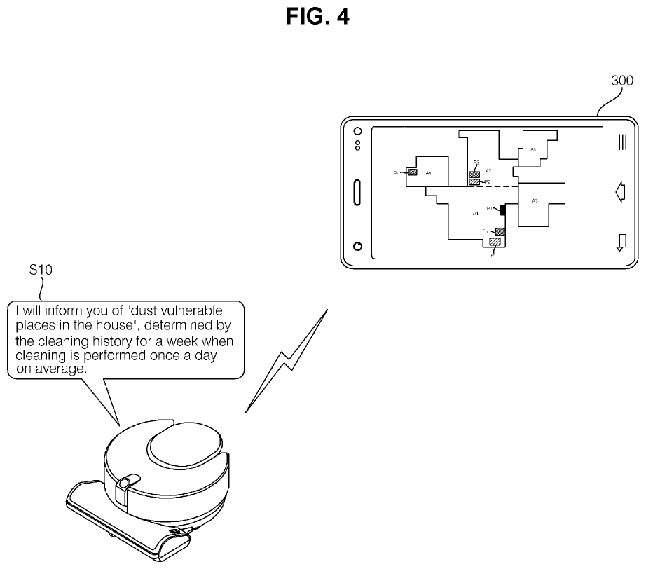

FIG. 4 is a diagram illustrating a terminal on which a map including dust information of the mobile robot according to an embodiment of the present disclosure is displayed.

As shown in FIG. 4, if the cleaning operation has been completed, the mobile robot 1 may output the result of cleaning completion by voice. The control unit 200 generates a guide message based on data sensed during cleaning, and outputs the guide message as the voice through the speaker of the output unit.

The control unit 200 may communicate with the voice recognition server to recognize the voice, and also receive and output data about audio guidance.

Furthermore, when a predetermined command is input through the manipulation unit, the mobile robot 1 may output the cleaning result by voice. For example, a cleaning period, a cleaning history, and a dust vulnerable point may be guided by voice. The dust vulnerable point is a point where a lot of dust accumulates. This is a point having a large amount of dust within a region.

On the other hand, the mobile robot 1 transmits a cleaning progress to the terminal 300 during cleaning. When cleaning has been completed, the cleaning result including the dust information and the obstacle information is transmitted to the terminal 300.

Thus, the terminal 300 displays the cleaning result on the screen.

Furthermore, the terminal 300 may display the map including the dust information. On the map, dusty points are marked as dust positions P1 to P5. The dust positions may be differently displayed according to the order of the amount of dust.

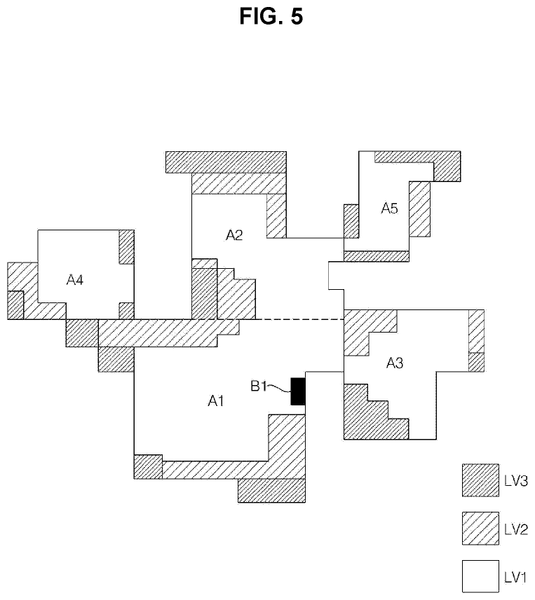

FIG. 5 is a diagram illustrating the map including the dust information of the mobile robot according to an embodiment of the present disclosure.

As shown in FIG. 5, the terminal 300 may display the dust information on the map based on the data received from the mobile robot 1.

The terminal 300 may divide the amount of dust in stages and display it in at least three levels. The terminal 300 may be displayed in different patterns or colors depending on the level.

For the convenience of description, the amount of dust is divided into three levels. However, it is apparent that the dust amount may be divided into a plurality of levels, such as four or five levels, if necessary, without being limited to the accompanying drawing.

Based on a maximum dust amount, it is divided into three levels and displayed differently.

The mobile robot 1 collects, stores, and accumulates, as dust data, information about dust detected by the dust sensor during the travel, thus calculating the dust information.

The control unit 200 determines the position of the main body during the travel, and stores the position when the dust sensor is operated along with the dust information. The dust position may be divided on the basis of a cell and stored.

Furthermore, when cleaning is repeated a certain number of times, the control unit may count and store the number of dust detections at a position where dust is detected.

The control unit 200 accumulates data for a certain period of time, and determines dusty positions in the order of the number of dust detections based on the accumulated data.

Furthermore, if the positions having a large number of dust detections are adjacent to each other during cleaning, the control unit 200 may set adjacent regions as one region to set it as the dust vulnerable region.

For example, if the number of dust detections is higher than a certain value in the right front of a sofa, the left front of the sofa, under the sofa, and on the right side of the sofa, a plurality of adjacent positions from the sofa may be considered as one region around the sofa, and be set as the dust vulnerable region.

Further, the control unit 200 may put a weight as the number of dust detections increases, and set it as a dust position or a priority cleaning region.

Furthermore, the control unit 200 may match the position of an object in a region with the dust position by the image acquisition unit and the obstacle recognition unit, thus storing dust information based on the object.

In the case of inputting a cleaning command for a dusty place, the control unit 200 may first clean adjacent positions when there are a plurality of dusty places.

The control unit 200 may output a priority cleaning position based on the object through voice guidance.

The control unit 200 may set a different cleaning method in response to the type of an object adjacent to the cleaning position.

For example, in the case of a carpet, the mobile robot 1 starts cleaning with the strongest suction force by turbo-on in a carpet mode. In the case of cleaning a region around a sofa, the mobile robot cleans while slowly travelling around the sofa by 30 cm. In the case of cleaning a bed, the mobile robot may clean a region under the bed in a zigzag fashion, and clean a region around the bed while travelling 30 cm.

The control unit 200 transmits the accumulated dust information to the server or the terminal.

The server or the terminal may set a cleaning scenario for a cleaning command based on the dust information. Furthermore, the server or the terminal may recognize the cleaning command based on the object and transmit it to the mobile robot, based on matching data about the position of the object and the dust position.

The terminal 300 may transmit the cleaning command to the mobile robot 1 to clean a dusty point according to a user's input. Furthermore, the terminal 300 may transmit the cleaning command for each level according to the amount of dust.

When cleaning has been completed by the mobile robot 1, the terminal 300 may update and display the map based on the newly detected dust information.

The terminal 300 may accumulate the dust information, calculate an average on a weekly or monthly basis, generate and display statistics for dust information based on the dusty point.

The terminal 300 may input the object-based cleaning command into the mobile robot 1 by matching the type of the obstacle (object) recognized by the obstacle recognition unit with the dust position.

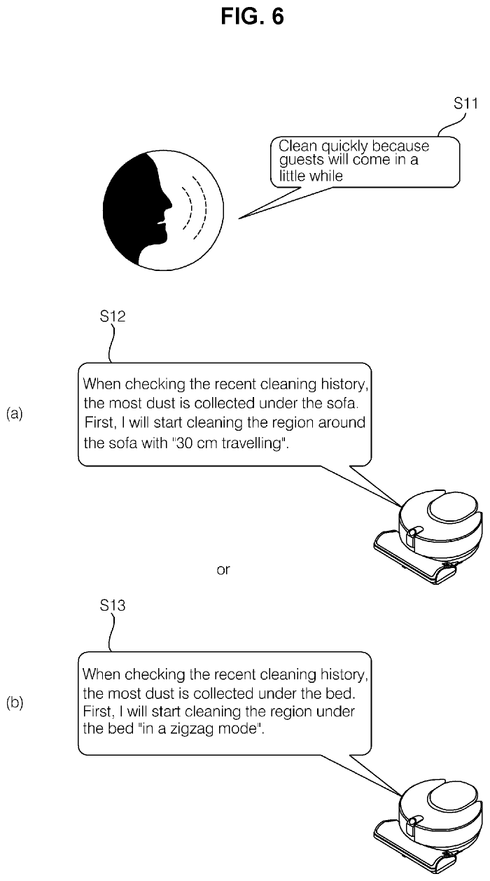

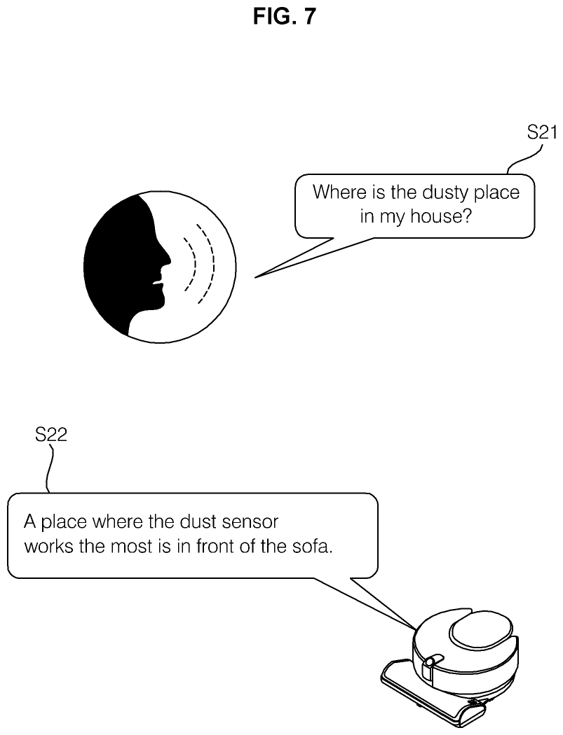

FIGS. 6 and 7 are diagrams illustrating a control method using a voice command of the mobile robot according to an embodiment of the present disclosure.

As shown in FIG. 6(a), a user may give a voice command to the mobile robot 1 (S11). The mobile robot 1 may receive the voice command through the audio input unit 120 to recognize voice and thereby perform a corresponding operation.

The mobile robot 1 transmits the voice command to the voice recognition server (not shown), receives the control command for the voice command, and thereby performs the corresponding operation. Furthermore, a response message for the voice command may be transmitted to the voice recognition server to receive voice data corresponding to the response message and then output it through the output unit.

When the command ‘Clean quickly because guests will come in a little while’ is input, the mobile robot 1 may start cleaning in response to the voice recognition result through the voice recognition server. In some cases, the control command corresponding to the voice recognition result may be received through a home-appliance management server, so that a cleaning operation may be performed.

The mobile robot 1 may determine the cleaning operation performed in a short time, with respect to the following expression, ‘in a little while’, ‘guests’, ‘quickly’, and ‘clean’ according to the voice recognition result.

The mobile robot 1 may give voice guidance to preferentially clean the dusty point based on a recent cleaning history, in response to the voice command, and may start cleaning.

For example, a response message for cleaning a region around the sofa with a lot of dust while travelling in the region by 30 cm according to the recent cleaning history may be output as the voice guidance (S12).

Furthermore, as shown in FIG. 6(b), the mobile robot 1 may output a response message for cleaning a dusty region under the bed in a zigzag mode as the voice guidance (S13).

The mobile robot 1 generates a response message including at least one of a cleaning reason, a dust position, a cleaning position, and a cleaning method, based on the voice recognition result for the voice command, and then outputs the response message by voice.

The mobile robot 1 may set the cleaning position based on the dusty point, on the basis of at least one of the recent cleaning history and the accumulated dust information.

Furthermore, the mobile robot 1 may divide data on a newly sensed dust position and a dust position which is set based on the accumulated data into recent data and accumulated data, and may provide the voice guidance.

Furthermore, the mobile robot 1 may output the voice guidance for the cleaning position based on the object located in the region.

As shown in FIG. 7, if the voice command is input from a user, the mobile robot 1 first determines whether it is a cleaning command for a specific operation based on the voice recognition result, and then is operated.

Further, the mobile robot 1 generates a response message corresponding to a question about the cleaning history or the cleaning result, based on the voice recognition result, and then outputs it by voice.

For example, in the case of a question about the dusty position, the mobile robot 1 may provide voice guidance instructing that there is a lot of dust in front of a sofa, such as ‘A place where the dust sensor works the most is in front of the sofa’, based on the cleaning history and the cleaning result.

Thus, the mobile robot 1 may move to a point where the bed is located, clean a region under the bed in a zigzag manner, and also clean a region around the bed.

The mobile robot 1 may set a cleaning position based on dust information when a cleaning command for dust is input, may set a cleaning operation based on the surrounding region of the corresponding object when a cleaning command based on an object is input, and may perform the cleaning operation based on the surrounding dust information.

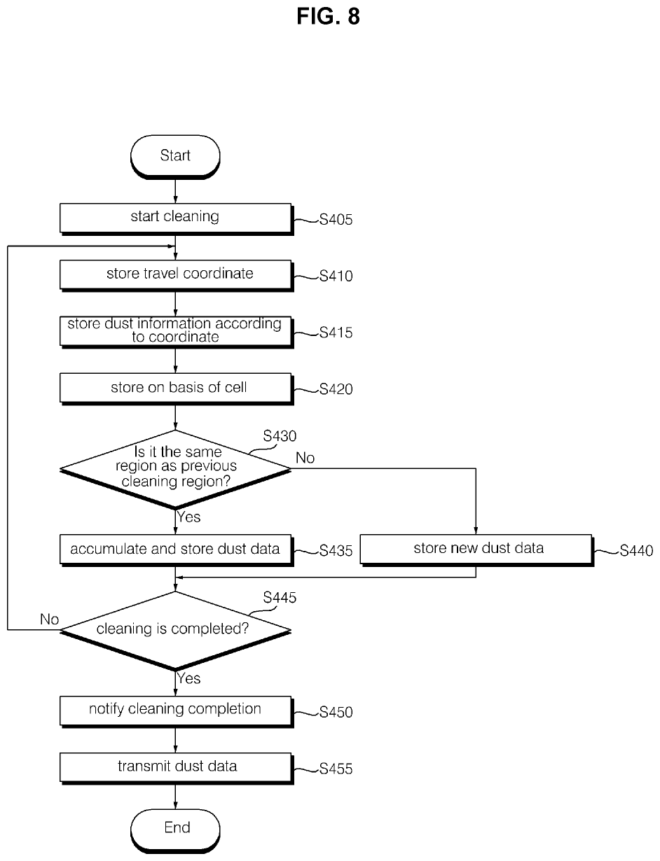

FIG. 8 is a flowchart illustrating a control method of the mobile robot according to an embodiment of the present disclosure.

As shown in FIG. 8, the mobile robot 1 starts cleaning in response to the control command (S405). The mobile robot 1 sucks foreign matter while travelling in a predetermined region.

The mobile robot 1 stores the position of the main body according to the movement as a travel coordinate (S410). Furthermore, if dust is sensed through the dust sensor, the mobile robot 1 stores information about dust as dust data along with the travel coordinate (S415).

The mobile robot 1 divides the region into cells, and stores dust information and travel coordinates on the basis of the cell (S420).

The mobile robot 1 determines whether it is the same region as a previous cleaning region, that is, the same cell, and accumulates and stores dust data (S435). Furthermore, the mobile robot 1 may count the number of dust detections for a position where dust is detected, on the basis of the cell. In other words, if dust is detected again in a cell where dust is detected during previous cleaning, the number of dust detections is increased and dust data is stored.

On the other hand, if dust is detected in a new cell, new dust data is stored for a corresponding cell (S440).

The cleaning and the storing of dust data are repeated until the cleaning for the region is completed (S410 to S445).

If the cleaning has been completed, the mobile robot 1 outputs a notification about cleaning completion (S450), and stores dust data. The mobile robot 1 may also update the map including the dust information based on the dust data.

Further, the mobile robot 1 transmits the dust data and the notification about the cleaning completion to the terminal or the server.

The terminal 300 displays a notification message about the cleaning completion on the screen, and also displays a map including dust information based on the received dust data.

The update of the map including the dust information may be performed and shared by either side of the mobile robot 1 and the terminal 300.

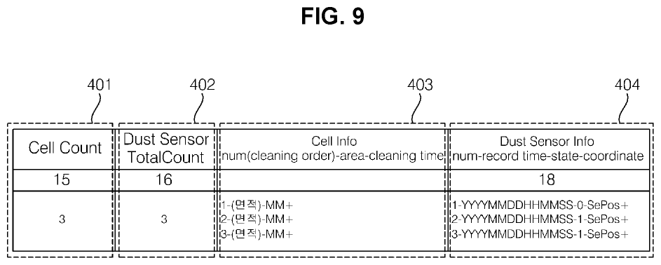

FIG. 9 is a diagram illustrating the dust information of the mobile robot according to an embodiment of the present disclosure.

As shown in FIG. 9, the mobile robot 1 stores dust information.

The mobile robot 1 stores a cleaning start time, a model name, a main version, an UI version, a vision version, a battery level, a battery level at the time of docking completion, a cleaning mode, a cleaning time, and a docking status after cleaning is completed.

The mobile robot 1 stores the number of docking attempts when docking fails, stores time taken to complete the docking, and stores connection to or disconnection from a charging station when cleaning is completed or during travel, the number of times a threshold is crossed during cleaning, the occurrence of emergency, and time when a monitoring mode is set through the image acquisition unit.

Furthermore, the mobile robot 1 stores dust information during the travel.

The mobile robot 1 stores a recognized area 401 during cleaning (number of cells), the number 402 of operations of the dust sensor during cleaning, cell information 403, and dust-sensor information 404.

The cell information 403 stores an area for each cell and a cleaning time for the corresponding cell. Furthermore, the cell information 403 is added on the basis of the cell. In some cases, the cell information may be individually stored for each region.

Furthermore, the dust-sensor information 404 is data which is stored when the dust sensor is operated.

The dust-sensor information 404 is recorded in an order in which the dust sensor is operated. The dust-sensor information 404 stores, as coordinates, information about the order in which the sensor is operated, an operation time, a status, and a position.

Thus, the control unit 200 may check the number of cells in which dust is detected in the region based on the stored data, determine the position of the cell in which dust is detected, and determine the number of dust detections.

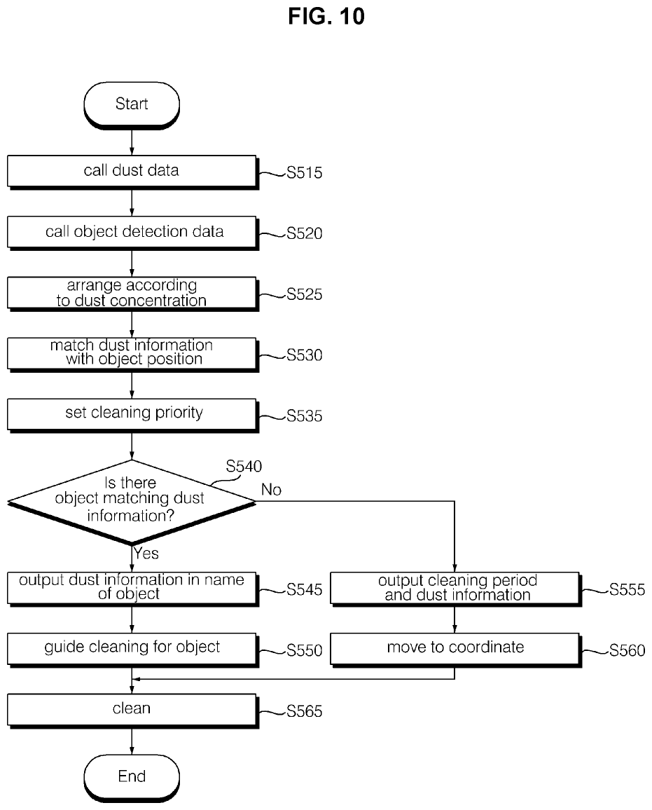

FIG. 10 is a flowchart illustrating a cleaning method according to the dust information of the mobile robot according to an embodiment of the present disclosure.

As shown in FIG. 10, when a voice command is input through the audio input unit 120, the mobile robot 1 transmits data to the voice recognition server, and calls the stored dust data in response to the received voice recognition result.

According to the voice recognition result, the mobile robot 1 calls data on a thing, in particular, an object included in the voice command (S520). It is possible to call data on an obstacle located in the region, that is, an object by the obstacle recognition unit.

The mobile robot 1 determines a dusty point and a dust position from dust data and arranges it according to an order corresponding to the dust amount, thus determining a dusty position (S525).

Since the dust data includes a position where dust is detected and the number of dust detections, the control unit 200 may determine the order corresponding to the dust amount and the position based on the dust data.

The control unit 200 matches the dust position with the position of the object in the region (S530), so that the control unit 200 determines an object located around a dusty point, or dust information around the object.

When dust positions are distributed within a predetermined distance, the control unit 200 may set a certain region based on a corresponding position and set it as a dust vulnerable region.

The control unit 200 sets a cleaning priority based on the object or the dust vulnerable region (S535).

If there is an object matching with the dust information, the object name is output as the dust information (S545).

For example, as shown in FIG. 8, the control unit 200 generates a response message about dust information in the name of an object, such as in front of a sofa or under a bed, based on the object, in response to the voice command asking where a dusty point is, and outputs the response message through the output unit by voice.

Furthermore, the mobile robot 1 may output a cleaning guide for a cleaning position and a cleaning method of a corresponding object in response to the cleaning command. For example, after outputting a guide indicating that there is a lot of dust in front of the sofa by voice, it is possible to output voice guidance indicating that cleaning is performed in front of the sofa.

On the other hand, if there is no object matching the dust information, a cleaning period and dust information may be output (S555). The mobile robot moves to the coordinate of the dust position based on dust information in response to the cleaning command.

The mobile robot 1 starts cleaning on the basis of a designated object or a dust position based on the dust information according to the cleaning command (S565).

The mobile robot according to this embodiment operated as described above may be implemented in the form of an independent hardware device, and be driven in the form of being included in another hardware device such as a micro processor or a general purpose computer system as at least one or more processors.

The above description is merely illustrative of the technical spirit of the present disclosure, and various modifications and changes may be made by those skilled in the art to which the present disclosure pertains without departing from the essential characteristics of the present disclosure. Therefore, embodiments disclosed in the present disclosure are not intended to limit the technical spirit of the present disclosure but merely illustrate the technical spirit without departing from the scope of the present disclosure.

What is claimed is:

1. A mobile robot comprising:
a main body configured to travel in a region;
a driving unit configured to move the main body;
a dust sensor configured to detect dust; and
a control unit configured to store dust information detected by the dust sensor during the travel, and to match information about a dusty point with information about an object located around the dusty point from the dust information, thus performing a cleaning operation on the basis of the dust information or the object.

2. The mobile robot of claim 1, wherein the control unit sets a cleaning position based on the dust information, if a cleaning command for dust is input, and
the control unit sets a cleaning position according to surrounding dust information on the basis of a surrounding region of the object, if a cleaning command for the object is input.

3. The mobile robot of claim 1, wherein the control unit sets a different cleaning method according to a type of the object.

4. The mobile robot of claim 1, wherein the control unit determines a position of the main body during the travel, and stores as the dust information a position when the dust sensor is operated together with dust detection, and
the control unit stores the dust information by determining whether dust is detected on the basis of a cell and counting a number of dust detections of a corresponding cell, and determines a dusty point by accumulating data for a predetermined time.

5. The mobile robot of claim 1, wherein the control unit first cleans a position with priority or an adjacent position when there are a plurality of dusty points, and
the control unit sets, as a dust vulnerable region, one region connecting adjacent points when points with a large number of dust detections are adjacent to each other.

6. The mobile robot of claim 1, further comprising:
an image acquisition unit configured to photograph surroundings of the main body; and
an obstacle recognition unit configured to recognize an object by analyzing an image photographed by the image acquisition unit,
wherein the control unit determines the object located around the dusty point, by comparing a dust position based on the dust information and a position of the object, based on information about the object, or determines a cleaning command by calculating the dusty point around the object and matching the dust information with the object.

7. The mobile robot of claim 1, further comprising:
an audio input unit configured to collect sound; and
an output unit configured to output voice guidance,
wherein the control unit generates a response message including at least one of a cleaning reason, a dust position, a cleaning position, and a cleaning method, based on a voice recognition result for a voice command which is input through the audio input unit, and then outputs the response message through the output unit by voice.

8. The mobile robot of claim 7, wherein the control unit sets the cleaning position based on at least one of a recent cleaning history and accumulated dust information, in response to a cleaning command where a position to be cleaned is not specified.

9. The mobile robot of claim 7, wherein the control unit generates a response message on the basis of at least one of a cleaning position based on the object, a position of the dusty point, and an object located around the dusty point.

10. The mobile robot of claim 7, wherein the control unit first determines whether the voice command is a cleaning command for a specific operation, if the voice command is input, and
the control unit generates a response message corresponding to a question about the cleaning history or the cleaning result, and then outputs the response message by voice.

11. The mobile robot of claim 1, further comprising:
a terminal configured to communicate with the main body,
wherein the terminal divides an operation into a plurality of steps according to an amount of dust based on the dust information received from the main body, and displays the dust information for each level on a map.

12. A method of controlling a mobile robot comprising:
detecting dust by a dust sensor during travel;
storing dust detection and a position of a main body;
calculating a dust detected position and a number of dust detections at that position when cleaning has been completed, and calculating a dusty point, thus storing the dusty point as dust information;
matching and storing information about an object located around the dusty point; and
setting and cleaning a region to be cleaned base on the dust information or a position of the object, according to an input cleaning command.

13. The method of claim 12, further comprising:
setting a cleaning position based on the dust information, if a cleaning command for dust is input; and
setting a cleaning position on the basis of surrounding dust information about a surrounding region of the corresponding object, if a cleaning command is input based on the object.

14. The method of claim 12, further comprising:
setting a different cleaning method in response to a type of the object.

15. The method of claim 12, further comprising:
first cleaning a position with priority or an adjacent position when there are a plurality of dusty points; and
setting, as a dust vulnerable region, one region connecting adjacent points when points with a large number of dust detections are adjacent to each other.

16. The method of claim 12, further comprising:
photographing surroundings of a main body as an image during travel;
analyzing the image to recognize the object;
determining the object located around the dusty point;
calculating the dusty point around the object; and
matching a position of the object with the dust information.

17. The method of claim 12, further comprising:
inputting a voice command; and
generating a response message including at least one of a cleaning reason, a dust position, a cleaning position, and a cleaning method, based on a voice recognition result for the voice command, and then outputting the response message by voice.

18. The method of claim 17, further comprising:
setting the cleaning position based on at least one of a recent cleaning history and accumulated dust information, in response to a cleaning command where a position to be cleaned is not specified; and
generating and outputting the response message based on the object for the cleaning position.

19. The method of claim 17, further comprising:
first determining whether the voice command is a cleaning command for a specific operation, if the voice command is input; and
generating the response message based on the dusty point or an object located around the dusty point, when the voice command is a question about the cleaning history or the cleaning result, and then outputting the response message by voice.

20. The method of claim 12, further comprising:
transmitting the dust information to a terminal configured to communicate with the main body;
dividing, by the terminal, an operation into a plurality of steps according to an amount of dust based on the dust information; and
displaying a map including the dust information which is differently displayed for each level according to an amount of the dust.
